(19) United States
(12) Patent Application Publication
(10) Pub. No.: US 2022/0049186 A1
(43) Pub. Date: Feb. 17, 2022

(54) COMPOSITION AND METHOD FOR PREPARING THERMOCHROMIC PIGMENT DISPERSIONS AND THEIR USE IN COLOR-CHANGING CANDLES WITH IMPROVED COLOR REVERSIBILITY AND BURN PERFORMANCE

(71) Applicants: John C. Brahms, Morris Plains, NJ (US); Debra Magalhaes, Bloomfield, NJ (US); Stephanie Myers, Rosedale, NY (US); Kanan George, Pompton Lakes, NJ (US)

(72) Inventors: John C. Brahms, Morris Plains, NJ (US); Debra Magalhaes, Bloomfield, NJ (US); Stephanie Myers, Rosedale, NY (US); Kanan George, Pompton Lakes, NJ (US)

(21) Appl. No.: 16/990,010

(22) Filed: Aug. 11, 2020

(51) Int. Cl. C11C 5/00; C09K 9/02

(52) U.S. Cl. CPC C11C 5/004; C09K 2211/1018; C09K 9/02

(57) ABSTRACT

The present invention relates to color changing candles and the use of encapsulated thermochromic pigments to achieve the desired metachromatic effect. The invention may include a stable dispersion of a thermochromic pigment that uses an encapsulated thermochromic pigment; an amphiphilic solvent; a dispersant; and an oil. The present invention may include a method for making a candle containing thermochromic pigment and fragrance that may include pre-weighing ingredients needed to make batch; adding melted wax into vessel; adding thermochromic colorant to vessel and mixing for 10-15 minutes; adding dye and fragrance and blend till homogeneous; pouring mixture into candle jars equipped with wicks; and allowing candles to cure at room temperature overnight.

### FIELD OF INVENTION

The field of this invention relates generally to color changing candles and the use of encapsulated thermochromic pigments to achieve the desired metachromatic effect.

### PRIOR ART

Thermochromic pigments are well known to those skilled in the art as is their use in various applications. U.S. Pat. No. 3,560,229 describes phenol based thermochromic materials that can be used as color changing pigments that change color at about 150 C. U.S. Pat. No. 4,028,118 disclosed the use of thermochromic pigments based on the electron donor-acceptor concept that change color over a range from −40 to 80 C. This patent further describes the encapsulation of said thermochromic pigments to enhance the thermochromic characteristics and describes us in thermochromic printing inks, writing instruments and polymer sheets. U.S. Pat. No. 4,681,791 discloses the use of thermochromic pigments for textile application. U.S. Pat. No. 4,732,810 described reversible temperature-indicating material compositions based on electron donor/acceptor concept that provide superiority to previous technologies based either on metal salts or cholesterol liquid crystals. This patent further introduces the concept of encapsulation of thermochromic agents to enhance long term stability. U.S. Pat. No. 4,851,282 describes linear thermochromic materials and incorporating said materials into color changing fibers. The thermochromics materials are made via a sol-gel process and describe use of such material with inorganic, metallic or polymeric fibers. U.S. Pat. No. 5,480,482 also describes a class of reversible thermochromic pigments. This patent claims materials that undergo reversible color change in the range of 50-70 C. US 2003/0122113 A1, US 2005/0139142 A1 and U.S. Pat. No. 5,558,699 also describes a range of thermo-reversable color changing pigments. Other examples of reversible thermochromic compositions are disclosed in U.S. Pat. Nos. 4,865,648; 4,720,301; 4,957,949; 4,554,565; 4,421,560; 4,425,161; and 4,421,560.

There have been several patent disclosures of the use of thermochromic pigments embedded within a wax matrix to yield color changing candles. EP 1,090,977 describes wax and transparent gel candles containing encapsulated thermochromic and photochromic pigments that undergo a reversible color change from colored to colorless when lit. GB 2,358,193 describes the incorporation of thermochromic pigments into candle wax for the purpose of effectively monitoring wax temperature during manufacturing to ensure proper pour temperature and cooling time. In another embodiment of this invention the incorporation of thermochromic colorants into a sleeve that is wrapped around the candle is described. U.S. Pat. No. 6,165,234 described the application of thermochromic pigments to wax based candles. Said color changing systems comprise (a) an electron donor, (b) an electron-accepting organic compound, (c) a carrier which acts as an electron transfer medium and (d) an adjuster/inverter consisting of an aromatic aldehyde, ketone, ester fragrance or combinations thereof and (e) an inorganic salt selected from halide or nitrates of transition metals or alums. U.S. Pat. No. 6,200,129 discloses thermochromic candles consisting of two layers, each containing a different thermochromic pigment. The preferred embodiment of this invention envisions an over dipped taper candle. U.S. Pat. No. 6,461,392 discloses a clear plastic elastomer gel-based candle incorporating thermochromic pigments. U.S. Pat. No. 6,537,335 disclosed thermochromic candle compositions based on both wax and clear gels. Said thermochromic candles employ a combination of an encapsulated thermochromic pigment and a non-encapsulated thermochromic pigment.

### BACKGROUND OF INVENTION

Candles have been used since ancient times to provide light as well as ambience. Through the centuries a number of innovations have served to enhance the use experience. Addition of color to the wax has provided added visual appeal and the addition of scent has greatly broadened the appeal of candles which today have become an important room scenting vehicle. A more recent development has been employing thermochromic pigments in candles to deliver a visually striking color change effect. Though previously disclosed in the patent literature, previous executions of this technology have significant limitations that have prohibited their successful widespread commercial implementation. Specifically, the thermochromic compositions disclosed in the prior art use relatively high pigment loads which can have a negative impact on burn performance. An object of the present invention is an improved vehicle for implementing thermochromic pigments in candle applications.

### SUMMARY OF INVENTION

Herein disclosed is an improved compositions and methods for formulating thermochromic pigment into wax compositions for use in thermally activated color-changing candles. An object of the present invention is a stable high load dispersion of thermochromic pigment which easily disperses homogeneously into the candle wax matrix allowing for superior performance at low pigment loads. The dispersion includes a thermochromic pigment, an amphiphilic solvent, a dispersant and an oil. Candles employing specific wax compositions were, in combination with said dispersion, found to deliver superior burn performance coupled with compete reversibility. Another object of the present invention is an improved burn performance in comparison to executions of this technology described in the prior art. The application of this approach to a commercially viable color changing candles is described in detail below.

### DETAILED DESCRIPTION OF INVENTION

Thermochromic Pigment Dispersions: An element of the present invention may include the incorporation of the thermochromic pigments into a composition that is both compatible with and effectively disperses said pigment into the wax candle base. The dispersions include a thermochromic pigment; an amphiphilic solvent; a dispersant; and an oil.

Thermochromic Pigment: Thermochromic pigments suitable for use in the present invention have been previously disclosed in the abovementioned patents which are hereby incorporated by reference.

Microencapsulated pigments that go from colored to colorless upon heating, referred to as Leuco dyes, were found to give the best performance in this application yielded a color change below the melt temp of the wax but above room temperatures. A secondary non-thermochromic dye or pigment is incorporated into the candle wax to provide a wider range of color combinations. For this application, dyes were found to be preferable to pigments due to their ability to be used at lower levels than pigments as well as the fact that they are combustible organic materials which will pose no inherent limitations to burn performance. Non-limiting combinations of thermochromic and non-thermochromic dyes for use in candle formulation are disclosed in the examples below.

Through extensive experimentation, it was found that thermochromic pigments that undergo a color transition at approximately 31-35 C provided the best overall performance for the use in candle applications. This is because the color transition temperature must be above room temperature but below the melt temperature of the wax.

Specific thermochromic pigment particularly suited for this invention were obtained from United Mineral and Chemical Corporation, 1050 Wall Street, West Lyndhurst, N.J. USA. The following products were used:

33 C Color shift pigments.
TM-PDF-33-3111 RED->COLORLESS
TM-PDF-33-3113 MAGENTA->COLORLESS
TM-PDF-33-3121 YELLOW->COLORLESS
TM-PDF-33-5151 ORANGE->COLORLESS

35 C Color shift pigments
TM-PDF-35-3133 TURKISH BLUE->COLORLESS
TM-PDF-35-3134 BLUE->COLORLESS
TM-PDF-35-3139 GREEN->COLORLESS
TM-PDF-35-3141 BLACK->COLORLESS

An Oil: Nonlimiting examples of oils that may be used include, palm oil, sunflower oil, soybean oil, rapeseed oil, corn oil, medium chain triglycerides and coconut oil. Soybean oil was found to be preferred because of its compatibility with candle wax, low cost and ability to burn without producing excessive soot.

A Dispersant: Dispersants suitable for this invention include but are not limited to succinimide based dispersants. One commercially available succinimide based dispersant particularly useful for this invention is Lubrizol 2155.

An Amphiphilic Solvent: Amphiphilic solvents suitable for this invention include but are not limited to ethoxylated hydrogenated castor oil, linear alcohol ethoxylates, and sorbitan alkanoates. For the purpose of this invention sorbitan monooleate was found to be ideal.

Through extensive experimentation that the following combination offers superior performance when incorporated into a candle wax matrix.

### Formula:

| Ingredient(s) | (%) |
|---|---|
| Oil | 10-30 |
| Thermochromic Pigment | 20-30 |
| Dispersant | 01-10 |
| Amphiphilic solvent | 25-75 |

Based on extensive screening of oils, dispersants and amphiphilic solvents, the following combination was found to be both cost effective and provide consistently superior performance:

Formula: Ingredient (s)

| | |
|---|---|
| Soybean Oil (SBO) | 10-30% |
| Thermochromic Pigment | 20-30% |
| Lubrizol 2155 | 01-10% |
| Sorbitan Monooleate | 25-75% |

The following composition was found to give consistent performance and was used for prototype development:

Formula: Ingredient(s)

| | |
|---|---|
| Soybean Oil (SBO) | 20-25% |
| Thermochromic Pigment | 25% |
| Lubrizol 2155 | 5% |
| Sorbitan Monooleate | 45-50% |

Trials were conducted to determine the proper pigment load, the temperature of the pigment in order to give optimal color change. Oils, amphiphilic solvent, and dispersants were screened to provide optimal shelf life coupled with dispersibility into the wax matrix.

Post-processing of thermochromic pigment dispersion: The resulting pigment dispersions were further processed using a 3-roll mill resulting in greater stability over time. Milling provided the added advantage of reducing the particle size of the thermochromic pigment which allowed for greater opacity thus lower effective pigment load. The reduction of particle size of the pigment facilitated more even distribution in the wax base which also improved burn performance. Flame height, melt pool, and consumption rate improved as well as the cleanliness of the burn.

Non-thermochromic wax soluble dyes: Though the combination of thermochromic and non-thermochromic pigments was successfully reduced to practice, it was found that the best results were obtained by combining thermochromic pigments with wax soluble dyes. To achieve optimum range of colors it is necessary to combine the thermochromic pigment with a non-thermochromic colorant since most thermochromic pigments undergo a change from colored to colorless upon heating. Non-thermochromic oil soluble dyes were used alone or in combination to provide the desired range of colors. Non-limiting examples are as follows: CI Solvent Red 25, CI Solvent Red 27, CI Solvent Red 27, CI Solvent Yellow 16, CI Solvent Yellow 72, CI Solvent Blue 35, CI Solvent Blue 36, CI Solvent Blue 98, CI Solvent Orange 9.

The following color blends were used in prototype development:
a. RED DYE BLEND—CI Solvent Red 164, CI Solvent Red 25 and CI Solvent Red 27
b. YELLOW DYE BLEND—A blend of CI Solvent Yellow 16 and CI Solvent Yellow 72
c. BLUE DYE BLEND—A blend of CI Solvent Blue 36, CI Solvent Blue 35 and CI Solvent Blue 98
d. GREEN DYE BLEND—A blend of the CI Solvent Orange 98, CI Solvent Blue 36, CI Solvent Blue 35, CI Solvent Blue 98
e. VIOLET DYE BLEND—Blend of CI Solvent Red 164, CI Solvent Red 25, CI Solvent Red 27, CI Solvent Orange 98, CI Solvent Blue 36, CI Solvent Blue 35, CI Solvent Blue 98
f. ORANGE DYE BLEND—CI Solvent Orange 98

Thermochromic Pigment dispersions: Through extensive experimentation, it was found that specific combinations of thermochromic pigments and non-thermochromic dyes provide the best color contrast coupled with consistent reversibility. Specific combinations of thermochromic pigments and non-thermochromic dyes are described in detail below.

GtoW- Green -> white
Formula: Ingredient(s)

| | |
|---|---|
| Soybean Oil (SBO) | 20% |
| UMC TM-PDF-35-3139 | 25% |
| Lubrizol 2155 | 5% |
| Sorbitan Monooleate | 50% |

MtoW-Magenta -> white

| | |
|---|---|
| Soybean Oil (SBO) | 20% |
| UMC TM-PDF-33-3113 | 25% |
| Lubrizol 2155 | 5% |
| Sorbitan Monooleate | 50% |

BtoW-Blue -> white

| | |
|---|---|
| Soybean Oil (SBO) | 20% |
| UMC TM-PDF-35-3133 | 25% |
| Lubrizol 2155 | 5% |
| Sorbitan Monooleate | 50% |

OToW-Orange -> white

| | |
|---|---|
| Soybean Oil (SBO) | 25% |
| Hallcrest LLC TP31/031CO | 25% |
| Thermochromic Orange | |
| (31C) BPA FREE | |
| Lubrizol 2155 | 5% |
| Sorbitan Monooleate | 45% |

Thermochromic/Non-Thermochromic Blends:
Turquoise to Tan 0.25% VIOLET DYE BLEND, 99.75% BtoW
Orange to Yellow 1% YELLOW DYE BLEND, 99% OToW
Green to Pink 0.2% RED DYE BLEND, 99.8 GtoW
Rose to Amber 0.3% YELLOW DYE BLEND, 0.3% ORANGE BLEND, 99.4%

MtoW
Purple to Blue 0.3% BLUE DYE BLEND, 99.7% MtoW

Waxes: When using a wax to form the matrix of as in a conventional wax candle main body, the wax is preferably mainly constituted of at least one type of wax selected from a group of waxes that includes plant waxes (e.g., soy wax, rapeseed hardened oil, montan wax, palm wax, carnauba wax, candelilla wax, calnoba wax, vegetable tallow, oliquy wax, rice bran wax, jojoba wax and bayberry wax), and petroleum wax (e.g., paraffin wax having a melting point of from 45 to 120 degrees C., microcrystalline wax, petrolatum, paraffin oxide wax and petrolatum oxide, microcrystalline wax and crystalline wax).

A key element of this invention is the proper selection of wax. Extensive trials were conducted using a range of waxes. We found that the selection of the correct wax combination was critical for delivering a visually appealing thermo-reversable color change, full reversibility and good burn rate. Paraffin was found to give most consistent reversible color change. Soy waxes with high oil content, would result in a melt pool that was darker shade than the rest of the candle. Systematic studies were conducted to address this issue. We found the best solution was to recommend either 100% paraffin or a blend that consisted of 75%-80% paraffin and 20-25% soy wax.

Fragrance: It is important to note that fragrance has a significant impact on performance and must be considered as a key element of each formulation. It is well known to those skilled in the art that high levels of crystalline materials as well as inclusion of combinations of materials that can form highly colored reaction products such as Schiff bases are to be avoided. It is also important to avoid hydrophilic solvents, that can interfere with fragrance solubility in the wax matrix as well highly volatile fragrance materials that can be lost through evaporation during the candle making process. We found for the purpose of this invention that a fragrance load of 3-6% was ideal to deliver adequate hot throw fragrance intensity coupled with full thermo-reversibility and good burn performance.

Wicks: Different wicks were tested in order to find the optimum burn that would fall within the industry's acceptable parameter. It was determined a larger and preferably zinc cored wick was best depending on the wax and size of the candle jar. For some applications, Zinc-cored wicks were deemed undesirable, so we focused on non-zinc core wicks for the preferred embodiments of this invention. Helix wicks worked particularly well.

### EXAMPLES

The following examples are meant to be illustrative of the range of possible executions of this invention and are not intended to be limiting in any way.

### Example 1-8—Optimization of Thermochromic Pigment Dispersion

A number of trials were conducted to optimize the pigment dispersion for storage stability and homogeneous dispersibility into the candle wax matrix. Illustrative examples of said trials are summarized below.

### Example 1

| | |
|---|---|
| Thermochromic pigment | 30% |
| (H.W SANDS BLUE TCA4529 | |
| Sorbitan monooleate | 70% |

Results: When added to candle wax resulted in immediate settling of pigment particles as well as poor burn perforce.

### Example 2

| | |
|---|---|
| Thermochromic pigment- | 30% |
| H.W SANDS BLUE TCA4529 | |
| Sorbitan monooleate | 20% |
| Lubrizol 2155 | 5% |
| Epoxidized soybean oil | 25% |
| Soybean oil | 20% |

Results: Stable but highly viscous and didn't disperse readily into candle wax matrix.

### Example 3

| | |
|---|---|
| Thermochromic pigment- | 30% |
| H.W SANDS BLUE TCA4529 | |
| Sorbitan monooleate | 35% |
| Lubrizol 2155 | 5% |
| Soybean oil | 30% |

Results: Dispersion showed separation with soybean oil floating on top.

### Example 4

| | |
|---|---|
| Thermochromic pigment- | 25% |
| UMC Blue TMPDF31-3131 | |
| Sorbitan monooleate | 35% |
| Lubrizol 2155 | 5% |
| Soybean oil | 35% |

Results: Stable for 12 weeks at room temperature after which there was some soybean oil floating on top.

### Example 5

| | |
|---|---|
| Thermochromic pigment-UMC Blue TMPDF31-3131 | 25% |
| Sorbitan monooleate | 50% |
| Lubrizol 2155 | 5% |
| Soybean oil | 20% |

Results: Stable for 14 weeks

### Example 6

| | |
|---|---|
| Thermochromic pigment-UMC RED TMPDF31-3111 | 25% |
| Sorbitan monooleate | 50% |
| Lubrizol 2155 | 5% |
| Soybean oil | 20% |

Results: Stable for 14 weeks

### Example 7

| | |
|---|---|
| Thermochromic pigment-UMC Magenta TMPDF31-3113 | 25% |
| Sorbitan monooleate | 50% |
| Lubrizol 2155 | 5% |
| Soybean oil | 20% |

Results: Stable for 14 weeks

### Example 8

| | |
|---|---|
| Thermochromic pigment-UMC Yellow TMPDF31-3121 | 25% |
| Sorbitan monooleate | 50% |
| Lubrizol 2155 | 5% |
| Soybean oil | 20% |

Results: Stable for 13 weeks

### Example 9—Method for Making Thermochromic Pigment Dispersions

Liquid Thermochromic Pigment Dispersion best option—making procedure:

| Formula: Ingredient (s) | |
|---|---|
| Soybean Oil (SBO) | 20.0% |
| Thermochromic Pigment | 25.0% |
| Lubrizol 2155 | 5.0% |
| Sorbitan Monooleate | 50.0% |

Equipment: Heated Mixing Vessel with a high-speed immersion homogenizing agitator.

A Method for making thermochromic pigment dispersions may include the following steps: Step 110 may include pre-weighing ingredients needed to make batch; Step 120 may include adding sorbitan monooleate to mixing vessel. Step 130 may include heating the mixture to 150° F. and blending at 1500 rpms; Step 140 may include adding Lubrizol 2155 to vessel and mix for approximately 15 minutes until dispersant is fully incorporated into sorbitan monooleate; Step 150 may include adding thermochromic pigment to the vessel in increments, ensuring that the resulting mixture is homogeneous; Step 160 may include using a spatula if necessary, to scrape any pigment from the sides of the vessel, if the mixture becomes too viscous at any point during the addition of the pigment, adding a small amount of the pre-weighed Soybean Oil to the to reduce the viscosity; Step 170 may include adding the remaining Soybean Oil and increasing the mixer speed to 2500 rpms; Step 170 may include adding the remaining Soybean Oil and mixing the dispersion at 2500-3000 rpms for 30 min; and Step 180 may include transferring the mixture to final storage containers.

### Examples 10-12—Wax Optimization

Example 10 0.5% thermochromic pigment/dye blend, Straight Soy Wax, 6% Fragrance, Helix 35 Wick, Transition temp=31 C.

Results: Did not fully reverse

Example 11-0.5% thermochromic pigment/dye blend, mottled paraffin, 6% Fragrance, Helix 35 Wick, Transition temp=31 C.

### Results: Fully Reversed

Example 12-0.5% thermochromic pigment/dye blend, 75% mottled paraffin, 25% Soy wax, 6% Fragrance, Helix 35 Wick, Transition temp=31 C.

### Example 13—Candle Containing Thermochromic Pigment and Fragrance

| Formula: Ingredient | (%) |
|---|---|
| Wax | 95.5% |
| Thermochromic Pigment dispersion/ | 0.5% |
| non-thermochromic dye blend | |
| Fragrance | 4.0% |

Equipment: Heated Mixing Vessel with side sweep blade agitator.

A method for making a candle containing thermochromic pigment and fragrance may include the following steps: Step 210 includes pre-weigh ingredients needed to make batch; Step 220 includes adding melted wax into vessel; Step 230 includes adding thermochromic colorant to vessel and mix 10-15 minutes; Step 240 adding dye and fragrance and blend till homogeneous (Do not overheat once fragrance has been added); Step 250 includes pouring the mixture into candle jars equipped with wicks; and step 260 allowing the candles to cure at room temperature overnight.

### Examples 14-20 Candles with Thermochromic/Non-Thermochromic Blends to Deliver Desired Color Shifts

Candle compositions are prepared according to the method described in example 13 using the following composition.

| | |
|---|---|
| Wax (75% paraffin/25% soy wax) | 95.5% |
| fragrance | 4% |
| thermochromic dispersion/ | 0.5% |
| dye mixtures as described below | |

### Example 14—Green Top Pink

Thermochromic dispersion/dye mixture:

| | |
|---|---|
| GotW Thermochromic Dispersion- | 99.8% |
| RED DYE BLEND | 0.2% |

### Example 15—Purple to Blue

| | |
|---|---|
| MtoW Thermochromic Dispersion | 99.7% |
| BLUE DYE BLEND | 0.3% |

### Example 16—Orange to Yellow

| | |
|---|---|
| OtoY Thermochromic dispersion | 99% |
| YELLOW DYE BLEND | 1% |

### Example 17—Purple to Green

| | |
|---|---|
| MtoW Thermochromic Dispersion | 89.7% |
| BtoW Thermochromic Dispersion | 10% |
| GREEN DYE BLEND | 0.3% |

### Example 18—Pink to Yellow

| | |
|---|---|
| MtoW Thermochromic Dispersion | 99.4% |
| YELLOW DYE BLEND | 0.3% |
| ORANGE DYE BLEND | 0.3% |

### Example 19—Turquoise to Tan

| | |
|---|---|
| BtoW Thermochromic Pigment Dispersion | 99.75% |
| VIOLET DYE BLEND | 0.25% |

### Example 20 Green to Yellow

| | |
|---|---|
| GtoW Thermochromic Pigment Dispersion | 99.5% |
| YELLOW DYE BLEND | 0.5% |

### Example 21 Blue to Yellow

| | |
|---|---|
| BtoW Thermochromic Pigment Dispersion | 99.6% |
| YELLOW DYE BLEND | 0.4% |

After having sufficiently described the nature of the invention, as well as a preferred embodiments of the same, it is stated to all effects that the materials, shape, size and arrangement having been described can be modified provided that the changes do not mean an alteration of the essential features of the invention which are delineated in the following claims.

What is claimed is:

1) A stable dispersion of a thermochromic pigment comprising
a) An encapsulated thermochromic pigment;
b) An amphiphilic solvent;
c) A dispersant; and
d) An oil.

2) A thermochromic pigment dispersion according to claim 1, wherein said thermochromic pigment undergoes a reversible transition from colored to colorless at a temperature of between 30 C and 40 C.

3) A thermochromic pigment dispersion according to claim 2, wherein said thermochromic pigment undergoes a reversible transition preferably between 31 C and 37 C.

4) A thermochromic pigment dispersion according to claim 3, wherein said thermochromic pigment undergoes a reversible transition and preferably between 33 C and 35 C.

5) An encapsulated thermochromic pigment dispersion according to claim 1, wherein the encapsulated thermochromic pigment is at a level between 10-40 percent.

6) An encapsulated thermochromic pigment dispersion according to claim 1, wherein the encapsulated thermochromic pigment is at a level of between 20-30 percent.

7) An encapsulated thermochromic pigment dispersion according to claim 1, wherein the encapsulated thermochromic pigment is at a level of between and more preferably 24-26 percent.

8) An encapsulated thermochromic pigment dispersion according to claim 1, wherein a sorbitan monooleate acts as the amphiphilic solvent at a level between 25-75 percent.

9) An encapsulated thermochromic pigment dispersion according to claim 1, wherein a sorbitan monooleate acts as the amphiphilic solvent at a level between 40-60 percent.

10) An encapsulated thermochromic pigment dispersion according to claim 1, wherein a sorbitan monooleate acts as the amphiphilic solvent at a level between 45-55 percent.

11) The dispersant of claim 1 includes a succinimide based dispersant at a level between 1-10 percent.

12) The dispersant of claim 1 includes a succinimide based dispersant between 2.5-7.5 percent.

13) The dispersant of claim 1 includes a succinimide based dispersant between 4-6 percent.

14) The oil according to claim 1, wherein the oil is soybean oil at a level between 10-30 percent.

15) The oil according to claim 1, wherein the oil is soybean oil at a level between 15-25 percent.

16) The oil according to claim 1, wherein the oil is soybean oil at a level percent between 18-22 percent.

17) The candle according to claim 9 includes containing 0.01 to 5% of an encapsulated thermochromic pigment dispersion.

18) The candle according to claim 9 includes containing 0.1-1% of an encapsulated thermochromic pigment dispersion.

19) The candle according to claim 9 includes containing 0.25-0.75% of an encapsulated thermochromic pigment dispersion.

20) The candle according to claim 9 includes containing 0.4-0.6% of an encapsulated thermochromic pigment dispersion.

21) A method for making a thermochromic pigment dispersion comprising the steps of:
a. providing sorbitan monooleate to mixing vessel;
b. heating the sorbitan monooleate to 140-160° F. and blending at substantially 1500 rpms;
c. adding Lubrizol 2155 to the mixing vessel and mixing for approximately 15 minutes until dispersant is fully incorporated into sorbitan monooleate;
d. Slowly add thermochromic pigment into the mixing vessel in increments, ensuring that the resulting mixture is homogeneous;
e. scraping any pigment from the sides of the vessel; wherein if the mixture becomes too viscous at any point during the addition of the pigment,
f. adding a small amount of the pre-weighed Soybean Oil to the mixture vessel;
g. adding additional Soybean Oil and increase mixer speed to 2500 rpms;
h. adding remaining Soybean Oil and mixing dispersion at a rate of between 2500-3000 rpms for 30 minutes; and
i. transferring dispersion to final storage containers.

22) A method for making a Candle containing thermochromic pigment and fragrance comprising:
a. Pre-weighing ingredients needed to make batch;
b. adding melted wax into vessel;
c. adding thermochromic colorant to vessel and mixing for 10-15 minutes;
d. adding dye and fragrance and blend till homogeneous;
e. pouring mixture into candle jars equipped with wicks; and
f. allowing candles to cure at room temperature overnight.

23) The method of claim 16, wherein the wax includes one or more of paraffin wax, microcrystalline wax, palm was, bees wax and soy wax.

24) The method of claim 16, wherein the wax includes a blend of soy wax and paraffin wax containing 10-90% paraffin wax.

25) The method of claim 18, wherein the blend of soy wax and paraffin wax is 50-90% paraffin wax.

26) The method of claim 19, wherein the blend of soy wax and paraffin wax is 50-90% paraffin wax.

27) The method of claim 16, wherein the candle includes between 1 and 10% of a fragrance.

28) The method of claim 21, wherein the candle includes between 2-8% of a fragrance.

29) The method of claim 22, wherein the candle includes between 3-5% of a fragrance.

30) The method of claim 16, wherein the candle comprises a non-thermochromic dye that comprises one or more of the following: CI Solvent Red 25, CI Solvent Red 27, CI Solvent Red 27, CI Solvent Yellow 16, CI Solvent Yellow 72, CI Solvent Blue 35, CI Solvent Blue 36, CI Solvent Blue 98, and CI Solvent Orange 98

31) The method of claim 24, wherein the candle includes a non-thermochromic dye selected from the following combinations:
a. a Blend of CI Solvent Red 164, CI Solvent Red 25 and CI Solvent Red 27;
b. a blend of CI Solvent Yellow 16 and CI Solvent Yellow 72;
c. a blend of CI Solvent Blue 36, CI Solvent Blue 35 and CI Solvent Blue 98;
d. a blend of the CI Solvent Orange 98, CI Solvent Blue 36, CI Solvent Blue 35, CI Solvent Blue 98; and
e. a Blend of CI Solvent Red 164, CI Solvent Red 25, CI Solvent Red 27, CI Solvent Orange 98, CI Solvent Blue 36, CI Solvent Blue 35, CI Solvent Blue 98
